(19) United States
(12) Patent Application Publication
(10) Pub. No.: US 2025/0069046 A1
(43) Pub. Date: Feb. 27, 2025

(54) MAINTENANCE SUPPORT SYSTEM, MAINTENANCE SUPPORT METHOD, AND COMPUTER READABLE MEDIUM

(71) Applicant: Mitsubishi Electric Corporation, Tokyo (JP)

(72) Inventor: Tomohiro ONUKI, Tokyo (JP)

(73) Assignee: Mitsubishi Electric Corporation, Tokyo (JP)

(21) Appl. No.: 18/945,012

(22) Filed: Nov. 12, 2024

Related U.S. Application Data
(63) Continuation of application No. PCT/JP2022/026472, filed on Jul. 1, 2022.

(51) Int. Cl. G06Q 10/20; G06N 5/04; G06N 20/00; G06Q 10/0639

(52) U.S. Cl. CPC G06Q 10/20; G06N 5/04; G06N 20/00; G06Q 10/06395

(57) ABSTRACT

A maintenance support system (500) supports maintenance work to be carried out by a maintenance worker for an installation (30). An element unit inference model acquisition unit (107) sets an element unit inference model (108) for estimation of a maintenance work content in units of installation configuration elements as initial values of a maintenance work inference model (105) for estimation of the maintenance work content for the installation (30). A maintenance work inference unit (109) estimates the maintenance work content to be presented to the maintenance worker by applying the maintenance work inference model (105) to a feature quantity of an abnormality. A maintenance work learning unit (104) iteratively evaluates whether the maintenance work content has been effective or not for cancellation of the abnormality, learns an effective maintenance work content concerning the feature quantity of the abnormality, and updates the maintenance work inference model (105).

### CROSS REFERENCE TO RELATED APPLICATION

This application is a Continuation of PCT International Application No. PCT/JP2022/026472, filed on Jul. 1, 2022, which is hereby expressly incorporated by reference into the present application.

### TECHNICAL FIELD

The present disclosure relates to a maintenance support system, a maintenance support method, and a maintenance support program to support maintenance work to be carried out by a maintenance worker for an installation.

### BACKGROUND ART

Among conventional installation maintenance support systems, there is a system that, upon occurrence of an abnormality in an instrument, determines a status classification of the instrument, extracts identical or similar cases from a case database, and displays maintenance work contents in descending order of score based on a certainty factor. In the case database, the maintenance work contents in past, the certainty factor, and the status classifications of the instrument are associated with one another.

Further, there is an installation maintenance support system to infer a maintenance work content, as disclosed in Patent Literature 1, for instance. The installation maintenance support system disclosed in Patent Literature 1 is a system to learn instrument operation information, instrument phenomenon information, and information on maintenance work contents and to infer the maintenance work content based on results of learning, upon acquisition of new instrument operation information or new instrument phenomenon information.

### CITATION LIST

### Patent Literature

Patent Literature 1: JP 2020-154662 A

### SUMMARY OF INVENTION

### Technical Problem

The conventional installation maintenance support systems carry out learning for identifying a maintenance work content for some sort of installation as an object, identify the maintenance work content with use of the results of learning, for a new event having occurred in the object installation, and make a presentation thereof to a maintenance worker. As for the conventional installation maintenance support systems, however, a contrivance for applying information learned for a particular installation to an installation having different specifications is not disclosed. That is, even though the learned information may be directly applied to installations having exactly the same specifications, information needed for identification of the maintenance work content needs to be relearned for an installation having different specifications.

There is a possibility, however, that the information can be learned on a premise that the same maintenance work content should be presented in response to an event having occurred in an installation having different specifications as long as a physical cause thereof is the same.

In case where a new installation is developed with appropriation of a portion of an installation, for instance, the maintenance work content can be identified with appropriation of the learning result for an appropriated site because the appropriated site has exactly the same mechanism.

More specifically, on condition that an analysis result of a current waveform of a motor used in a site indicates a particular feature quantity, it can be determined that deterioration of a component has occurred and such identification as necessity to replace the component as the maintenance work content can be carried out. The learning result can be utilized across installations as long as the same site is utilized.

In the conventional installation maintenance support systems, even events that can be treated as the same sort in this manner are individually learned for each installation. Accordingly, there has been a problem in that computer resources for learning have to be prepared each time an installation is developed and in that relearning with long-time calculation has to be carried out depending on a scale of a learning object or capacity of the computer. In the conventional installation maintenance support systems, further, even if identification of the maintenance work content based on learning in an installation for events that can be treated as the same sort as described above has been completed, a result thereof cannot be utilized in the other installations. Accordingly, there has been a problem in that the maintenance work content cannot be identified for the event of the same sort until individual learning in each of the installations is completed. In the conventional installation maintenance support systems, further, for provision of a certainty factor for the maintenance work content to be presented, the certainty factor is individually calculated even for the event that can be treated as the same sort as described above. Accordingly, there has been a problem in that decrease in population parameter of data for calculation of the certainty factor, compared with learning in a plurality of installations, may lower credibility of the certainty factor.

The present disclosure mainly aims at reducing costs associated with learning of the maintenance work contents in a plurality of installations differing in specifications and improving the certainty factor of the maintenance work content to be presented to a maintenance worker.

### Solution to Problem

A maintenance support system according to the present disclosure is a maintenance support system to support maintenance work to be carried out by a maintenance worker for an installation, and includes:
an element unit inference model acquisition unit to acquire installation configuration elements that are configuration elements of the installation, to acquire an element unit inference model for estimation of a maintenance work content in units of the installation configuration elements, and to set the acquired element unit inference model as initial values of a maintenance work inference model for estimation of the maintenance work content for the installation;
a maintenance work inference unit to estimate the maintenance work content to be presented to the maintenance worker by applying the maintenance work inference model to a feature quantity of an abnormality extracted from sensor data for the installation; and
a maintenance work learning unit to iteratively evaluate whether the presented maintenance work content has been effective or not for cancellation of the abnormality, based on an evaluation of effectiveness of the presented maintenance work content, to learn an effective maintenance work content concerning the feature quantity of the abnormality, and to update the maintenance work inference model.

### Advantageous Effects of Invention

According to a maintenance support device of the present disclosure, costs associated with learning of the maintenance work contents can be reduced and the certainty factor of the maintenance work content to be presented to the maintenance worker can be improved.

### BRIEF DESCRIPTION OF DRAWINGS

FIG. 1 is a diagram illustrating a hardware configuration example of a maintenance support system according to Embodiment 1.

FIG. 2 is a diagram illustrating a functional configuration example of the maintenance support system according to Embodiment 1.

FIG. 3 is a diagram illustrating a construction example of a maintenance work inference model by a maintenance work learning unit according to Embodiment 1.

FIG. 4 is a diagram illustrating an example of an input form for a configuration of an installation from an installation configuration input unit according to Embodiment 1.

FIG. 5 is a diagram illustrating another example of an input form for the configuration of the installation from the installation configuration input unit according to Embodiment 1.

FIG. 6 is a diagram illustrating an example in which an element unit inference model is acquired in units of installation configuration elements by an element unit inference model acquisition unit according to Embodiment 1.

FIG. 7 is a diagram illustrating a configuration example of the element unit inference model according to Embodiment 1.

FIG. 8 is a diagram illustrating identification of a maintenance work content by a maintenance work inference unit according to Embodiment 1.

FIG. 9 is a diagram illustrating a detailed configuration example of a maintenance work recording unit according to Embodiment 1.

FIG. 10 is a flowchart illustrating an action example of the maintenance support system according to Embodiment 1.

FIG. 11 is a diagram illustrating a hardware configuration example of a maintenance support system according to a modification of Embodiment 1.

FIG. 12 is a diagram illustrating a functional configuration example of a maintenance support system according to Embodiment 2.

FIG. 13 is a diagram illustrating a functional configuration example of a maintenance support system according to Embodiment 3.

FIG. 14 is a diagram illustrating a functional configuration example of a maintenance support system according to Embodiment 4.

### DESCRIPTION OF EMBODIMENTS

Hereinbelow, the present embodiments will be described with use of the drawings. In the drawings, identical parts or corresponding parts are provided with identical reference characters. In description on the embodiments, description on the identical parts or the corresponding parts is omitted or simplified appropriately. Arrows in the drawings principally indicate flow of data or flow of processes. Further, relation among sizes of configuration members in the following drawings may be different from actual relation. In the description of the embodiments, further, orientations or positions such as upper, lower, left, right, fore, rear, front, or back may be designated. These expressions are given for convenience of description and do not restrict placement, directions, and orientations of devices, instruments, components, or the like.

### Embodiment 1

### ***Description of Configuration***

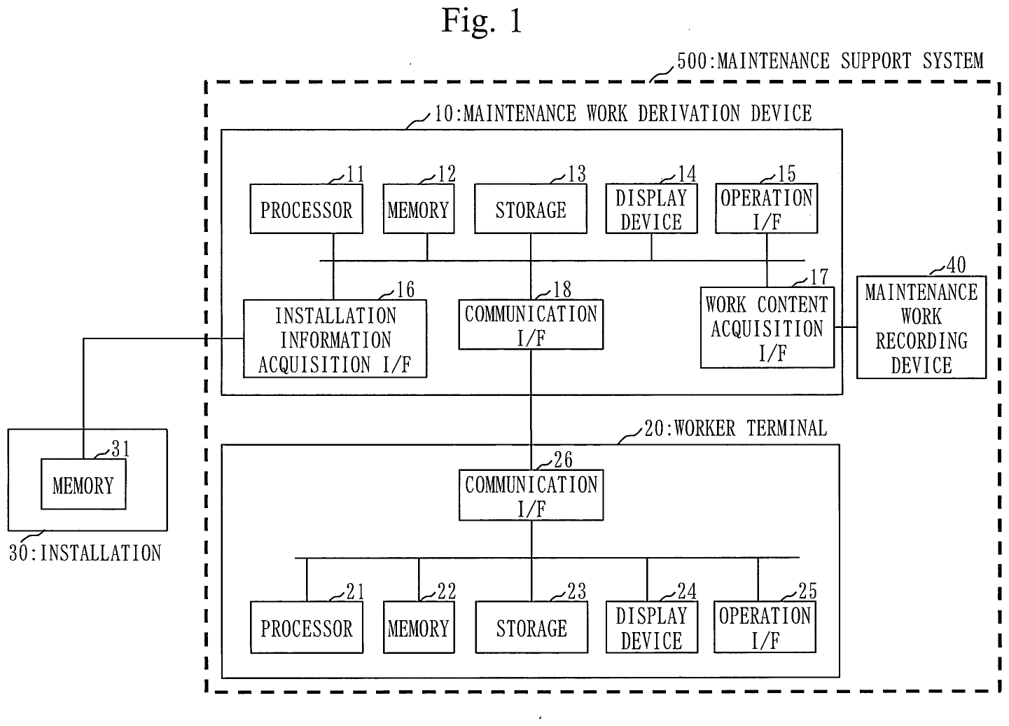

FIG. 1 is a diagram illustrating a hardware configuration example of a maintenance support system 500 according to the present embodiment.

The maintenance support system 500 supports maintenance work that is carried out by a maintenance worker for an installation. The maintenance support system 500 derives a maintenance work content for an installation 30 based on information on the installation 30 and presents the maintenance work content to a worker terminal 20 that is a terminal of a maintenance worker. The maintenance support system 500 may be referred to as an installation maintenance support system.

The maintenance support system 500 includes a maintenance work derivation device 10 and the worker terminal 20.

The maintenance work derivation device 10 may be referred to as a maintenance work content derivation device. The worker terminal 20 may be referred to as a maintenance worker operation terminal.

The installation 30 is an installation to be an object of maintenance work. Further, a maintenance work recording device 40 is a device in which achievement data of the maintenance work contents has been recorded.

The maintenance work derivation device 10 derives the maintenance work content for the installation based on the information on the installation 30 and the achievement data of the maintenance work contents recorded in the maintenance work recording device 40 and transmits the maintenance work content to the worker terminal 20.

The worker terminal 20 displays the maintenance work content, received from the maintenance work derivation device 10, on a display device 24 and thereby communicates the maintenance work content to the maintenance worker.

The maintenance work derivation device 10 includes a processor 11, a memory 12, a storage 13, a display device 14, an operation interface 15, an installation information acquisition interface 16, a work content acquisition interface 17, and a communication interface 18.

The processor 11 carries out computing for deriving the maintenance work content to be presented to the maintenance worker, with use of following information, for instance.
Programs and data stored in the storage 13
Installation setting parameter values and installation control parameter values, installation status parameter values, sensor data, and action log on a memory 31 of the installation 30 that have been acquired via the installation information acquisition interface 16
Achievement data of the maintenance work contents that has been acquired via the work content acquisition interface 17

The memory 12 retains temporary data to be used for computing in the processor 11.

The storage 13 stores a program representing a process for deriving the maintenance work content and associated data.

The display device 14 displays information needed for such operation as setting, execution, and termination to a user of the maintenance work derivation device 10.

The operation interface 15 provides an interface for such operation as setting, execution, and termination, for the user, such as a system operator, of the maintenance work derivation device 10.

The installation information acquisition interface 16 acquires values of control parameters and sensor data on the memory 31 of the installation 30.

The work content acquisition interface 17 acquires the achievement data of the maintenance work contents recorded in the maintenance work recording device 40.

The communication interface 18 communicates with the worker terminal 20. Specifically, data of the maintenance work content derived by the computing in the processor 11 is transmitted to the worker terminal 20.

The worker terminal 20 includes a processor 21, a memory 22, a storage 23, the display device 24, an operation interface 25, and a communication interface 26.

The processor 21 carries out computing for producing a display content with use of a program stored in the storage 23 and data of the maintenance work content received from the maintenance work derivation device 10.

The memory 22 retains temporary data to be used for the computing in the processor 21.

The storage 23 stores the program representing a process for displaying the maintenance work content and associated data.

The display device 24 displays information needed for such operation as setting, execution, and termination or the display content relating to the maintenance work content produced by the processor 21.

The operation interface 25 provides the maintenance worker with an interface for such operation as setting, execution, and termination.

The communication interface 26 communicates with the maintenance work derivation device 10. Specifically, the data of the maintenance work content derived by the maintenance work derivation device 10 is received.

In the installation 30, the memory 31 retains the installation setting parameter values and the control parameter values, the sensor data, and log data. Generally, the installation 30 controls action with use of such a control instrument as PLC and the memory 31 is equivalent to a memory included in the control instrument. PLC is an abbreviation for Programmable Logic Controller.

In the maintenance work recording device 40, a maintenance work content carried out by the maintenance worker is recorded. Specifically, such achievement data of the maintenance work content as follows is recorded.
Video records from a camera provided in an installation or in a vicinity of the installation or a head-mounted camera on the maintenance worker
Records of somatic condition or mental condition on a wearable terminal worn by the maintenance worker
Records of characters and voice inputted by the maintenance worker with use of a mobile terminal
Operation history in HMI (Human machine Interface) of an installation control terminal or display history on a manual display terminal

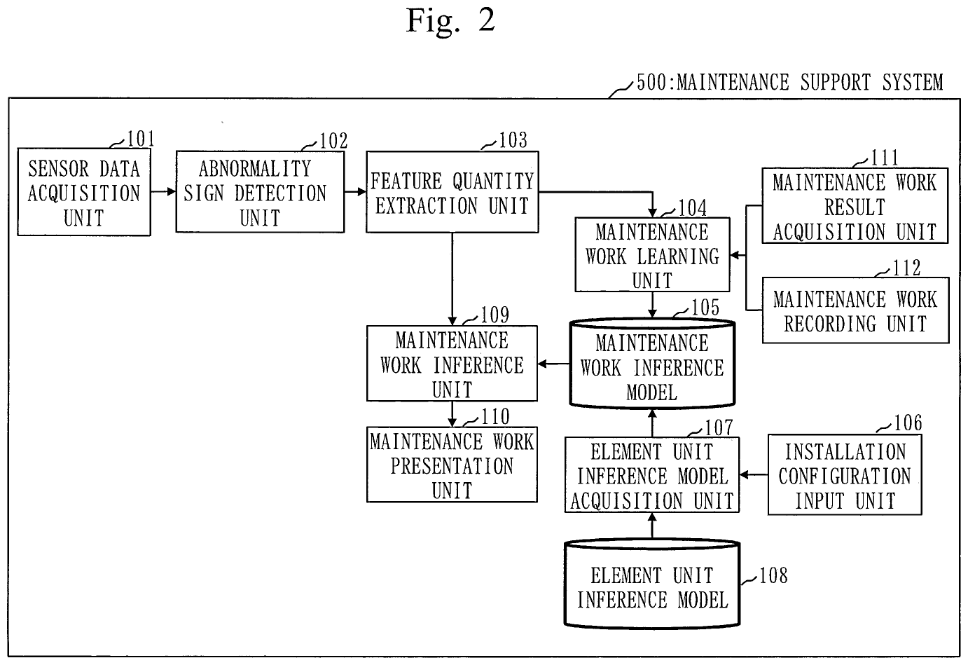

FIG. 2 is a diagram illustrating a functional configuration example of the maintenance support system 500 according to the present embodiment.

A sensor data acquisition unit 101 acquires the sensor data from the installation 30.

An abnormality sign detection unit 102 analyzes the sensor data and thereby detects a sign of an abnormality.

A feature quantity extraction unit 103 analyzes the sensor data and thereby calculates a feature quantity. For an analyzing method, there are schemes such as statistics including mean, dispersion, maximum, and minimum, frequency analysis including differential modulation, differential and integral calculus, peak detection, and Fourier transform, or autocorrelation. For instance, Fourier transform can be carried out for an analog waveform indicated by the sensor data and the feature quantity can be represented by a multidimensional vector with use of representative frequency components.

A maintenance work learning unit 104 iteratively evaluates whether the maintenance work content presented to the maintenance worker has been effective or not for cancellation of the abnormality, based on results of the maintenance work and evaluation of effectiveness of the work. Thus, the maintenance work learning unit 104 learns effective maintenance work contents and produces a maintenance work inference model.

Specifically, the maintenance work learning unit 104 learns the maintenance work content to be presented in response to the extracted feature quantity, based on the evaluation of the maintenance work results acquired by a maintenance work result acquisition unit 111 and constructs a maintenance work inference model 105.

In a first method concerning the evaluation, upon determination from the maintenance work result that the maintenance work content derived by a maintenance work inference unit 109 has contributed to a return to normal status of the installation, a high evaluation is given to the maintenance work content as being effective concerning the extracted feature quantity. In a second method, upon determination from the maintenance work result that the maintenance work content recorded by a maintenance work recording unit 112 has contributed to a return to the normal status of the installation, a high evaluation is given to the maintenance work content as being effective concerning the extracted feature quantity. By iteration of this, the maintenance work inference model 105 for identification of the maintenance work content appropriate to the feature quantity extracted from the sensor data can be constructed.

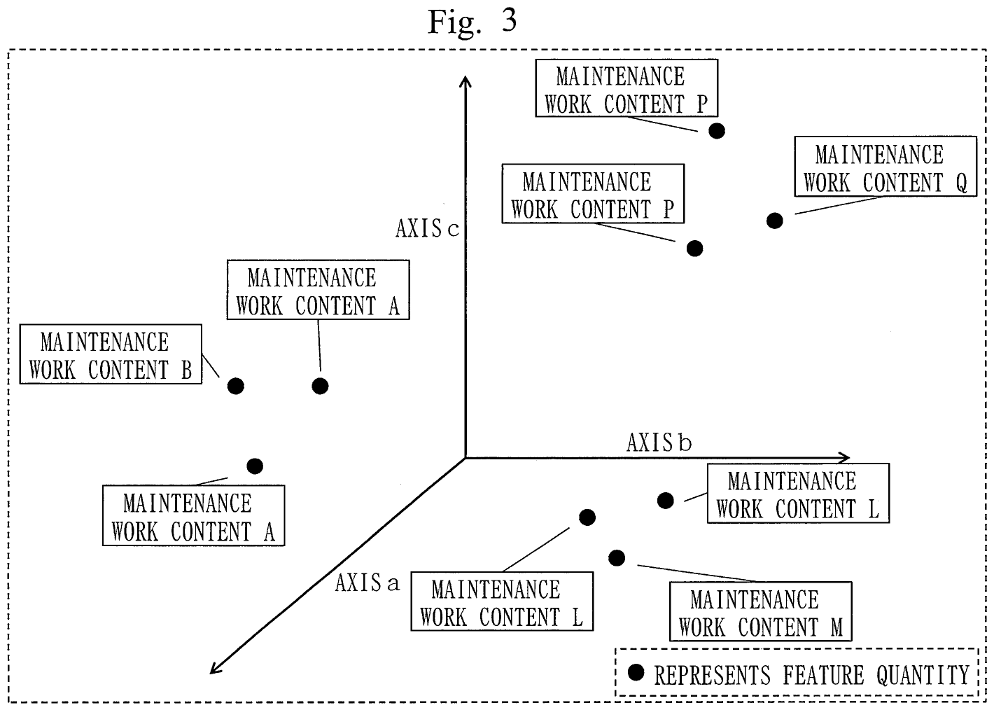

FIG. 3 is a diagram illustrating a construction example of the maintenance work inference model 105 by the maintenance work learning unit 104 according to the present embodiment.

FIG. 3 illustrates the example in which the maintenance work inference model 105 for the identification of the maintenance work content with extraction of three feature quantities a, b, and c from certain sensor data is constructed.

The maintenance work inference model 105 is a model for the identification of the maintenance work content appropriate to the feature quantities extracted from the sensor data, as described above.

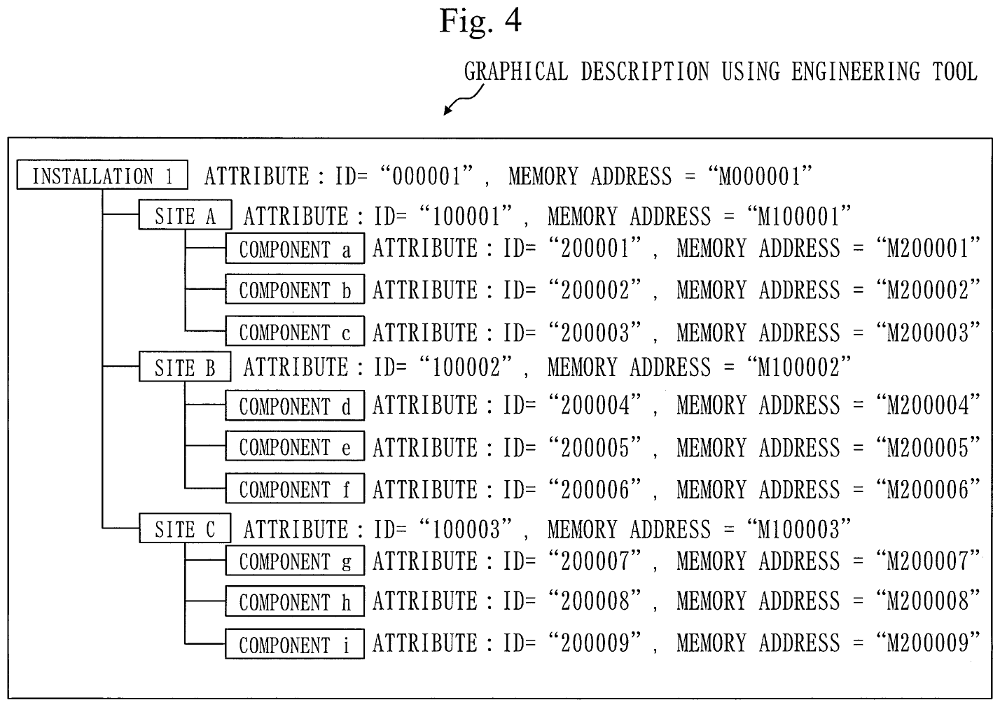

FIG. 4 is a diagram illustrating an example of an input form for a configuration of an installation from an installation configuration input unit 106 according to the present embodiment.

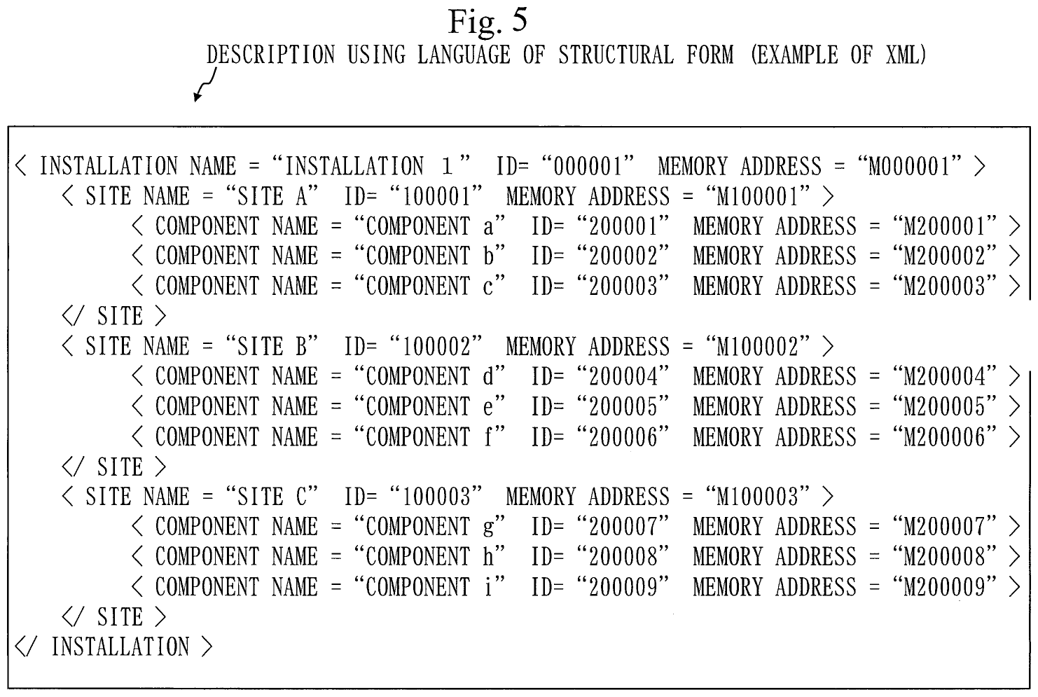

FIG. 5 is a diagram illustrating another example of an input form for the configuration of the installation from the installation configuration input unit 106 according to the present embodiment.

The installation configuration input unit 106 receives input of a configuration of an installation from a user of the maintenance support system 500. The user of the maintenance support system 500 is such a person as a system operator.

As the input form, such a graphical description using an engineering tool as illustrated in FIG. 4 is used, for instance. As the input form, alternatively, a description using a language of a structural form such as XML as illustrated in FIG. 5 may be used, for instance.

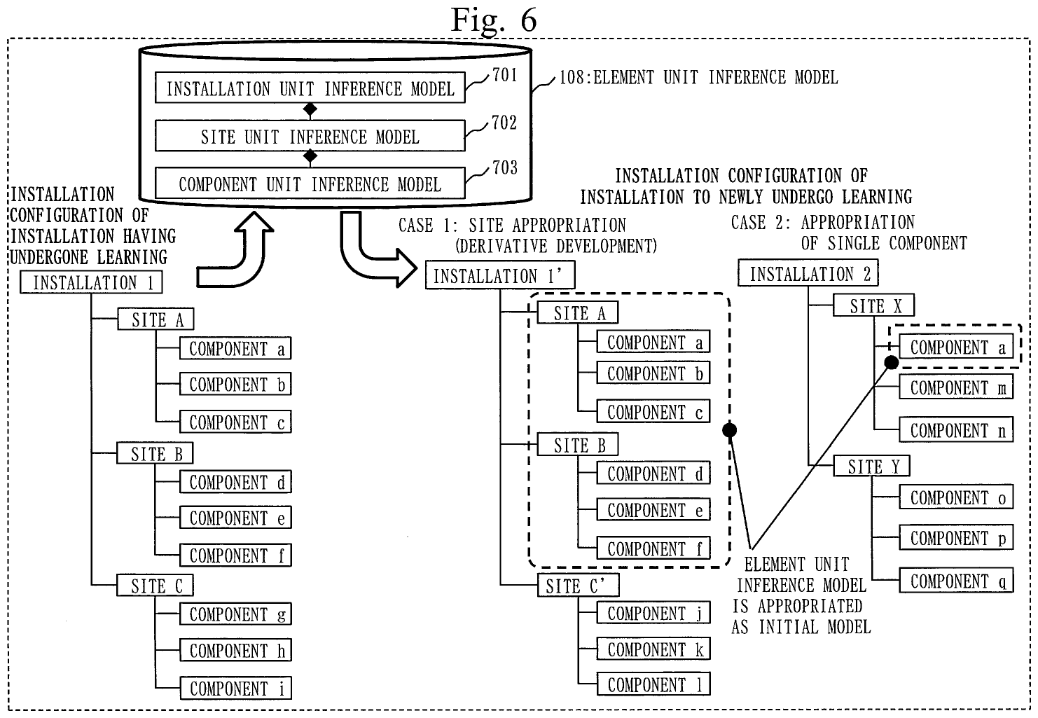

FIG. 6 is a diagram illustrating an example in which an element unit inference model 108 is acquired in units of installation configuration elements by an element unit inference model acquisition unit 107 according to the present embodiment.

The element unit inference model 108 is stored in a storage unit included in the maintenance support system 500. Functions of the storage unit included in the maintenance support system 500 are implemented by the memory 12, the storage 13, or the memory 12 and the storage 13.

The element unit inference model acquisition unit 107 initially acquires an installation configuration of an installation to be an object of maintenance from the user of the system via the installation configuration input unit 106. Then, the element unit inference model acquisition unit 107 acquires the element unit inference model 108 in the units of the installation configuration elements, based on the elements of the installation configuration.

Specifically, the element unit inference model acquisition unit 107 identifies the element unit inference model 108 that is reusable in the units of the installation configuration elements, in construction of the maintenance work inference model 105 and acquires the element unit inference model 108 for the same installation configuration element. The element unit inference model 108 is a maintenance work inference model having undergone learning in the units of the installation configuration elements.

Then, the element unit inference model acquisition unit 107 stores the acquired element unit inference model 108 in the units of the installation configuration elements, as an initial model in the maintenance work inference model 105. The units of the installation configuration elements are made of the installation, sites in the installation, and components in the sites, as illustrated in FIG. 6, for instance.

FIG. 6 represents such status as follows.
Types of installations include installation 1 type, installation 1′ type, installation 2 type, . . . . There may be a plurality of individuals (products) of installation 1 type, for instance.
Types of sites include site A type, site B type, site C type, . . . . There may be a plurality of individuals (products) of site A type, for instance.
Types of components include component a type, component b type, component c type, . . . . There may be a plurality of individuals (products) of component a type, for instance.

Herein, the ID for identification of a sort or a type of an installation is referred to as an installation classification ID. The ID for identification of a sort or a type of a site is referred to as a site classification ID. Further, the ID for identification of a sort or a type of a component is referred to as a component classification ID. ID is an abbreviation for IDentifier.

The element unit inference model acquisition unit 107 acquires the maintenance work inference models in the units of the installations or the sites or the components that are consistent in the installation classification ID or the site classification ID or the component classification ID and makes the maintenance work inference models elements of the maintenance work inference model 105, for instance. Alternatively, the user may directly designate a model to be used for a particular installation or site or component from among the element unit inference models 108, without using the classification IDs for the installations, sites, and components. Further, there may be a configuration in which the element unit inference model acquisition unit 107 acquires an element unit inference model in the unit of an installation configuration element and in which associated element unit inference models are then acquired in accordance with association among installations, sites, and components stored in the element unit inference model 108.

With use of FIG. 6, more specific description will be given.

In the element unit inference model 108, an installation unit inference model 701, site unit inference models 702, and component unit inference models 703 have been stored in advance for an installation configuration “installation 1” of an installation having undergone learning, for instance. If “site A+site B” are included in an installation configuration to newly undergo learning, the element unit inference model acquisition unit 107 acquires the “site unit inference model 702” for the “site A+site B” from among the “element unit inference models 108”. Similarly, if a “component a” is included in an installation configuration to newly undergo learning, the element unit inference model acquisition unit 107 acquires the “component unit inference model 703” for the “component a” from among the “element unit inference models 108”.

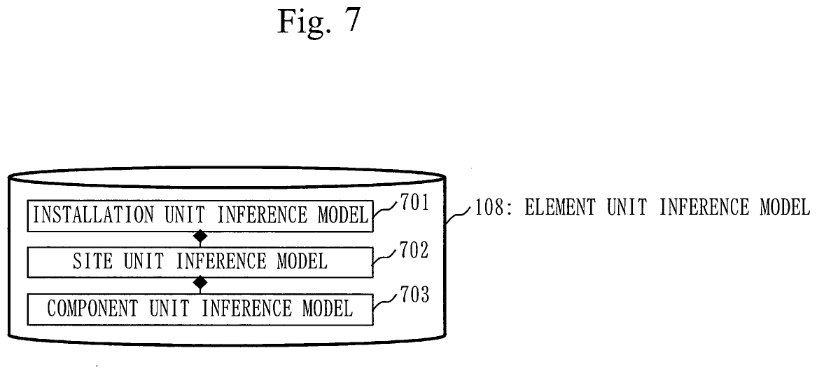

FIG. 7 is a diagram illustrating a configuration example of the element unit inference model 108 according to the present embodiment.

As illustrated in FIG. 7, the element unit inference model 108 saves maintenance work inference models having undergone learning, in the units of the installation configuration elements (installations, sites, components).

Each of the installation unit inference model 701, the site unit inference model 702, and the component unit inference model 703 is the maintenance work inference model 105 and is such a model as follows.
The installation unit inference model 701 is a model for identification of the maintenance work content based on the sensor data for the whole installation across the sites.
The site unit inference model 702 is a model for identification of the maintenance work content based on associated sensor data for the site and below.
The component unit inference model 703 is a model for identification of the maintenance work content based on only associated sensor data for a single component.

Further, each of the installation unit inference model 701, the site unit inference model 702, and the component unit inference model 703 has association conforming to a structure of the installation. That is, in conformity with the structure of an installation including one or more sites configuring the installation and one or more components configuring each of the sites, a particular installation unit inference model 701 is associated with one or more particular site unit inference models 702 and a particular site unit inference model 702 is associated with one or more particular component unit inference models 703.

Further, the units of the installation configuration elements do not have to have three layers as illustrated in FIG. 7 and may be provided with such a hierarchical structure as a configuration of one installation by a plurality of installations or a configuration of one site by a plurality of sites.

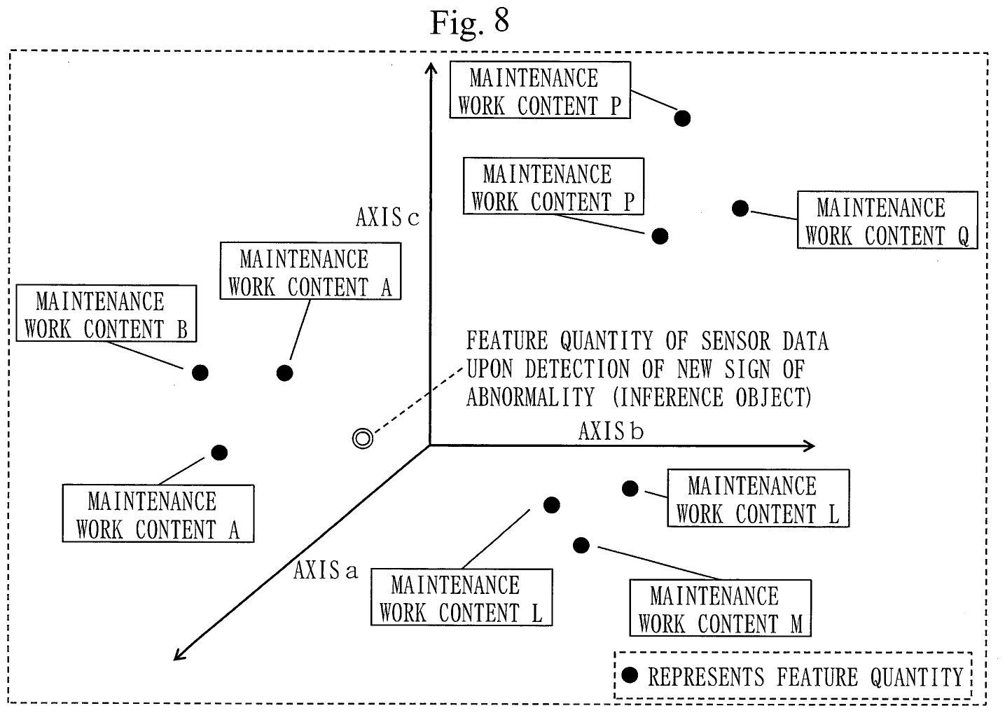

FIG. 8 is a diagram illustrating identification of a maintenance work content by the maintenance work inference unit 109 according to the present embodiment.

The maintenance work inference unit 109 infers the maintenance work content by applying the maintenance work inference model 105 to a feature quantity of an abnormality extracted from the sensor data. Upon detection of a new sign of abnormality, the maintenance work inference unit 109 identifies the maintenance work content by applying the maintenance work inference model 105 to the feature quantity extracted by the feature quantity extraction unit 103 based on the sensor data acquired from the installation.

As illustrated in FIG. 8, for instance, the maintenance work content is identified based on maintenance work contents tied to feature quantities existing in vicinities of the feature quantity of the sensor data for the installation at time of the detection of the new sign of abnormality and nearness of such distances as Euclidean distances or Mahalanobis' generalized distances. For instance, the maintenance work content for the feature quantity at the smallest distance is selected, the maintenance work content is selected with priorities given to a plurality of feature quantities in ascending order of the distance, or the maintenance work content with the certainty factor is calculated with a plurality of feature quantities within a given distance weighted in accordance with the distances.

A maintenance work presentation unit 110 makes a presentation of the maintenance work content identified by the maintenance work inference unit 109 to the maintenance worker. If there are a plurality of maintenance work contents to be presented, the maintenance work presentation unit 110 makes the presentation so that the maintenance worker can make a selection from the maintenance work contents being browsed. On condition that priorities or certainty factors have been given to the maintenance work contents on this occasion, the maintenance work presentation unit 110 additionally presents the priorities or the certainty factors at time of the selection of the maintenance work content. Alternatively, the maintenance work presentation unit 110 may sequentially present the maintenance work contents in descending order of the priority or the certainty factor without the selection from the maintenance work contents browsed by the maintenance worker.

The maintenance work result acquisition unit 111 acquires a result of cancellation of the sign of the abnormality by the maintenance work carried out by the maintenance worker. In a first method of determination of the result, it is determined that the sign of the abnormality has been canceled, on condition that the feature quantity of the sensor data returns from a value indicating the sign of the abnormality to a value equivalent to normal level. By contrast, it is determined that the sign of the abnormality has not been canceled on condition that the feature quantity of the sensor data remains at the value indicating the sign of the abnormality. In a second method, it is determined that the sign of the abnormality has been canceled, on condition that the installation status parameter values or information on the action log that has been acquired from the installation changes from information indicating the abnormality to information indicating normality. By contrast, it is determined that the sign of the abnormality has not been canceled on condition that the installation status parameter values or the information on the action log does not change from the information indicating the abnormality.

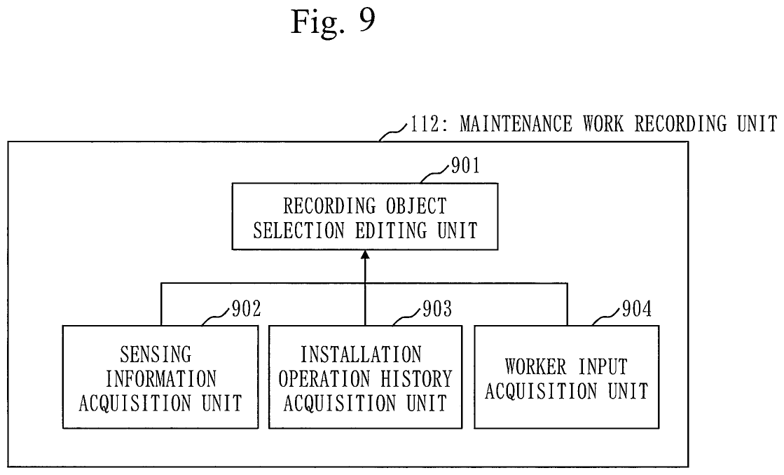

FIG. 9 is a diagram illustrating a detailed configuration example of the maintenance work recording unit 112 according to the present embodiment.

In the maintenance work recording unit 112, the contents of the maintenance work carried out by the maintenance worker are recorded. The maintenance work recording unit 112 includes a recording object selection editing unit 901, a sensing information acquisition unit 902, an installation operation history acquisition unit 903, and a worker input acquisition unit 904.

The recording object selection editing unit 901 receives a selection of information acquired by the sensing information acquisition unit 902, the installation operation history acquisition unit 903, and the worker input acquisition unit 904 and determined as being useful by the maintenance worker after completion of the maintenance work. The recording object selection editing unit 901 also receives edit such as clipping of moving images or sounds with section specification or range specification for operation history or manuals.

The sensing information acquisition unit 902 acquires sensing information such as video from the camera provided in the installation or in the vicinity of the installation or the head-mounted camera on the maintenance worker and information on somatic condition or mental condition from the wearable terminal worn by the maintenance worker.

The installation operation history acquisition unit 903 acquires such history as modification history in the installation setting parameters or operation history on HMI or the like of an installation control terminal.

The worker input acquisition unit 904 acquires such input as characters and voice inputted by the maintenance worker with use of the mobile terminal.

Incidentally, the functional configuration of the maintenance support system 500 according to the present embodiment may be placed in any manner so far as inconsistency is avoided with respect to each device of the installation 30, the maintenance work derivation device 10, the worker terminal 20, and the maintenance work recording device 40 of FIG. 1.

### ***Description of Action

Subsequently, action of the maintenance support system 500 according to the present embodiment will be described. An action procedure of the maintenance support system 500 is equivalent to a maintenance support method. Further, a program that implements the action of the maintenance support system 500 is equivalent to a maintenance support program.

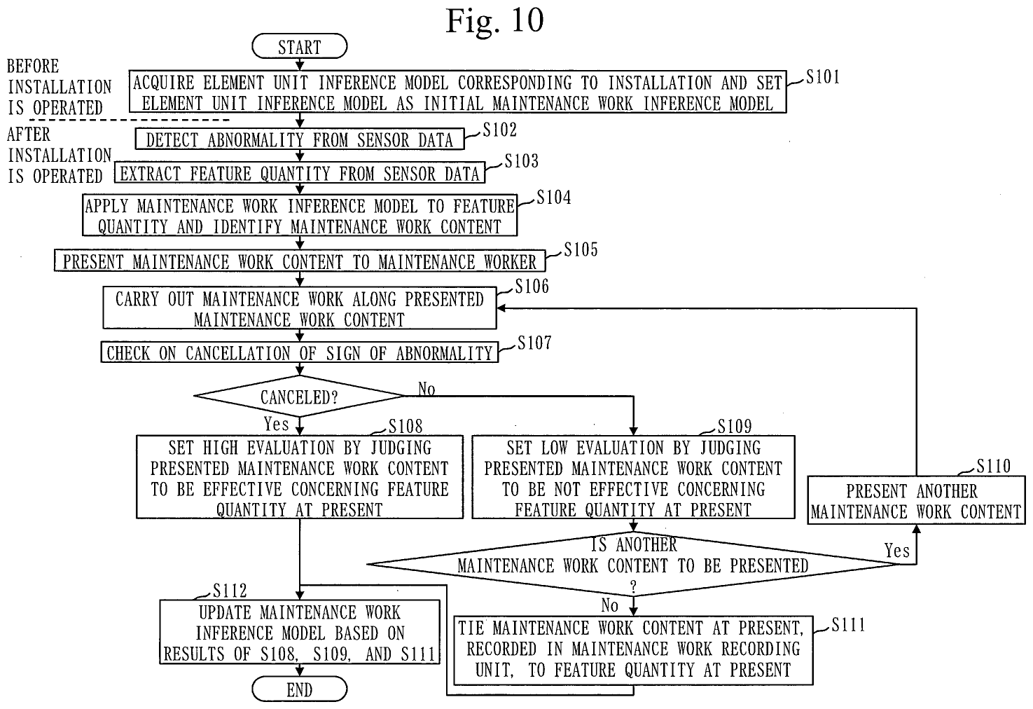

FIG. 10 is a flowchart illustrating an action example of the maintenance support system 500 according to the present embodiment.

Before the installation is operated, initially, a process of step S101 is carried out.

In step S101, the element unit inference model acquisition unit 107 acquires a maintenance work inference model in the units of available installation configuration elements from the element unit inference model 108 based on information on installation configurations retained by the installation configuration input unit 106 and sets the maintenance work inference model as the initial maintenance work inference model 105.

Specifically, the element unit inference model acquisition unit 107 acquires installation configuration elements that are configuration elements of the installation and acquires the element unit inference model 108 for estimation of the maintenance work content in the units of the installation configuration elements. The element unit inference model acquisition unit 107 sets the acquired element unit inference model 108 as initial values of the maintenance work inference model 105 for the estimation of the maintenance work content for the installation.

The installation configuration elements include classifications of installations, classifications of sites configuring the installations, and classifications of components configuring the sites, for instance. In the storage unit, the element unit inference model 108 is stored for each of the classifications of the installations, the classifications of the sites, and the classifications of the components. The element unit inference model acquisition unit 107 acquires the element unit inference model 108 for each of the classifications of the installations, the classifications of the sites, and the classifications of the components in the installations.

### Further Specifics are as Follows.

Before new learning, that is, before operation of the installation, the element unit inference model acquisition unit 107 determines whether any consistency in the installation configuration with the installations having undergone learning in the past exists or not in the installation configuration to be newly operated. The element unit inference model acquisition unit 107 determines whether the consistency exists or not, based on the classification IDs of the installation configuration elements such as installations, sites, or components.

If any consistent element exists, the element unit inference model acquisition unit 107 acquires the element unit inference model 108 tied to the consistent element and sets the element unit inference model 108 as the initial maintenance work inference model 105. At this time, the element unit inference model 108 acquired by the element unit inference model acquisition unit 107 is reused as the initial maintenance work inference model 105.

If any consistent element does not exist, the element unit inference model acquisition unit 107 does not set up the initial maintenance work inference model 105.

Subsequently, after the installation is operated, the processes of step S102 and subsequent steps are carried out.

In step S102, the abnormality sign detection unit 102 analyzes the sensor data and thereby detects an abnormality.

In step S103, the feature quantity extraction unit 103 extracts the feature quantity from the sensor data.

In step S104, the maintenance work inference unit 109 receives the feature quantity, applies the maintenance work inference model 105 to the feature quantity, and identifies the maintenance work content.

In step S105, the maintenance work presentation unit 110 receives the maintenance work content and makes a presentation of the maintenance work content to the maintenance worker. At this time, the maintenance work content that is the highest in the priority or the certainty factor may be mechanically presented. Further, a selection request from the maintenance worker for a plurality of maintenance work contents provided with the priorities or the certainty factors may be received and the presentation may be made.

In step S106, the maintenance work is carried out by the maintenance worker along the maintenance work content presented by the maintenance work presentation unit 110.

In step S107, the maintenance work result acquisition unit 111 checks on the cancellation of the sign of the abnormality.

If the sign of the abnormality has been canceled, the processes proceed to step S108.

If the sign of the abnormality has not been canceled, the processes proceed to step S109.

If the sign of the abnormality has been canceled, the maintenance work learning unit 104 makes a high evaluation by judging the presented maintenance work content to be effective concerning the feature quantity at present, in step S108.

If the sign of the abnormality has not been canceled, the maintenance work learning unit 104 makes a low evaluation by judging the presented maintenance work content to be not effective concerning the feature quantity at present, in step S109.

In step S110, further, the maintenance work presentation unit 110 mechanically selects a maintenance work content that is second highest in the priority or the certainty factor, if any, or selects a maintenance work content based on a received selection request from the maintenance worker and presents the maintenance work content to the maintenance worker.

If any maintenance work content to be presented does not exist, the maintenance work recording unit 112 ties the maintenance work content at present to the feature quantity at present, in step S111.

In step S112, further, the maintenance work learning unit 104 updates the maintenance work inference model 105 based on results of step S108, step S109, and step S111.

In the maintenance support system 500 according to the present embodiment, as described above, if any consistency in the installation configuration with the installations having undergone learning in the past exists, an element unit inference model for a concerned element is acquired from the “element unit inference model 108” and is set as the initial model of the “maintenance work inference model 105”. Then, the maintenance support system 500 updates the “maintenance work inference model 105” based on achievements while the installation is operated. Further, if any consistency in the installation configuration with the installations having undergone learning in the past does not exist, the initial model of the “maintenance work inference model 105” does not exist and the maintenance support system 500 constructs the “maintenance work inference model 105” from scratch based on the achievements while the installation is operated.

Herein, description will be given with use of a specific example, concerning how production of the maintenance work inference model 105 is made more efficient by setting of the element unit inference model 108 acquired by the element unit inference model acquisition unit 107 as the initial maintenance work inference model 105.

Herein, a maintenance work content “determine that deterioration of a component has occurred and carry out component replacement on condition that an analysis result of current waveform of a motor used in a site indicates a particular feature quantity” is used as the example.

A maintenance work content “carry out component replacement in response to this current waveform of a motor” is identified (step S104) and is presented to the maintenance worker (S105). If the maintenance worker having received this presentation carries out the maintenance work as is presented and succeeds, the certainty factor of the presented content is increased (step S108). If this process is iterated ten times, for instance, the maintenance work content “carry out component replacement in response to this current waveform of a motor” becomes all the more reasonable presented content. It is assumed that a maintenance work inference model having the certainty factor of the presented content increased has been produced by ten times iteration of such a process in an installation A. By appropriation of the maintenance work inference model for an installation B with the same classification ID, the certainty factor of the presented content can be cumulatively increased as in the process on the eleventh and subsequent times in the installation B. With further ten times execution of the process in the installation B, the maintenance work inference model having a high certainty factor by undergoing the process twenty times in total can be produced. In absence of such appropriation of the maintenance work inference model between installations, the maintenance work inference model having the equivalently high certainty factor cannot be produced until the process is carried out twenty times in each of the installation A and the installation B.

### ***Description of Effects of Present Embodiment***

In the maintenance support system according to the present embodiment, as described above, such characteristic processes as follows are carried out.

(A) A process in which, before operation of an installation, the element unit inference model acquisition unit acquires installation configuration elements of the installation to be an object of maintenance, acquires an inference model having undergone learning in the units of the same installation configuration elements from the element unit inference model, and sets the inference model as an initial maintenance work inference model

(B) A process in which, upon detection of an abnormality by the abnormality sign detection unit, the maintenance work content is inferred by application of the efficiently produced maintenance work inference model to a feature quantity of the abnormality

(C) A process in which the maintenance work learning unit iteratively evaluates whether the maintenance work content has been effective or not for cancellation of the abnormality, based on results of the maintenance work acquired by the maintenance work result acquisition unit, learns the effective maintenance work content, and produces a maintenance work inference model

According to the maintenance support system of the present embodiment, an effect is obtained in that costs associated with production of the model can be reduced by the above processes of (A) to (C). In particular, the above process (A) produces an effect in that the certainty factor of the maintenance work content to be presented to the maintenance worker can be improved compared with learning in a single installation. Though a model having a high certainty factor can be produced by spending of long time even in a single installation, increase in success rate of the maintenance work and reduction in costs associated with the maintenance work itself can be achieved if a model having a high certainty factor can be used from beginning.

In the maintenance support system according to the present embodiment, as described above, the maintenance work can be made more efficient by presentation of the maintenance work content to the maintenance worker for an installation and, moreover, information needed for identification of the maintenance work content can be shared among a plurality of installations having different specifications. According to the maintenance support system of the present embodiment, therefore, the costs associated with learning of the maintenance work contents can be reduced and the certainty factor of the maintenance work content to be presented to the maintenance worker can be improved.

In the maintenance support system according to the present embodiment, further, the maintenance work content to be carried out is presented to the maintenance worker. According to the maintenance support system of the present embodiment, therefore, an effect is obtained in that time required for the maintenance work can be shortened by removal of time for the maintenance worker himself or herself to investigate and examine the maintenance work content.

In the maintenance support system according to the present embodiment, further, the evaluation of effectiveness of the maintenance work content concerning the feature quantity is cumulatively updated based on success or failure in the maintenance work. According to the maintenance support system of the present embodiment, therefore, an effect is obtained in that credibility of the priority or the certainty factor of the maintenance work content to be presented to the maintenance worker can be continuously increased with continued operation of the system.

In the maintenance support system according to the present embodiment, further, the element unit inference model can be stored in the units of the configurations of installations. Thus, in new development of an installation, the learning results for an installation of derivative development origin or installations for which the same sites or components are utilized can be reused. According to the maintenance support system of the present embodiment, therefore, an effect is obtained in that computer resources and time required for construction of the maintenance work inference model can be reduced.

According to the maintenance support system of the present embodiment, additionally, an effect is obtained in that the maintenance work content even for a sign of an abnormality having not undergone learning in an installation to be newly developed can be identified with use of the learning results for the installation of derivative development origin or the installations for which the same sites or components are utilized.

According to the maintenance support system of the present embodiment, additionally, an effect is obtained in that the credibility of the priority or the certainty factor of the maintenance work content to be presented to the maintenance worker can be increased because learning is carried out based on a larger number of achievements than is carried out for only one installation that is newly developed.

### ***Description of Hardware Configuration Example***

Hardware configurations of the maintenance work derivation device 10 and the worker terminal 20 according to the present embodiment will be described with use of FIG. 1. The maintenance work derivation device 10 and the worker terminal 20 are referred to as devices of the maintenance support system.

The devices of the maintenance support system are computers. The devices of the maintenance support system each include a processor and include other pieces of hardware such as a memory, a storage, various types of interfaces, and a display device. The processor is connected to the other pieces of hardware through signal lines so as to control the other pieces of hardware.

Functions of the devices of the maintenance support system are implemented by software, for instance.

The processor is a device to execute the maintenance support program. The maintenance support program is a program to implement the functions of the devices of the maintenance support system.

The processor is an IC to execute a computing process. Specific examples of the processor are CPU, DSP, and GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory is a storage device to temporarily store data. A specific example of the memory is SRAM or DRAM. SRAM is an abbreviation for Static Random Access Memory. DRAM is an abbreviation for Dynamic Random Access Memory.

The storage is a storage device to save data. A specific example of the storage is HDD. Further, the storage may be a portable storage medium such as SD (registered trademark) memory card, CF, NAND flash, flexible disk, optical disk, compact disk, Blu-ray (registered trademark) disk, or DVD. Here, HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

An input-output interface is an interface for connection with input and output devices. A specific example of the input-output interface is a port of USB or HDMI (registered trademark). USB is an abbreviation for Universal Serial Bus. HDMI (registered trademark) is an abbreviation for High-Definition Multimedia Interface.

The communication interface is an interface for communication with external devices. A specific example of the communication interface is a port of Ethernet (registered trademark) or a device to carry out radio communication.

The maintenance support program is executed in the devices of the maintenance support system. The maintenance support program is read into the processor and is executed by the processor. In the memory, not only the maintenance support program but also an OS is stored. OS is an abbreviation for Operating System. The processor executes the maintenance support program while executing the OS. The maintenance support program and the OS may be stored in the storage. The maintenance support program and the OS stored in the storage are loaded into the memory and are executed by the processor. Incidentally, a portion or all of the maintenance support program may be integrated into the OS.

The devices of the maintenance support system may each include a plurality of processors to substitute for the processor. Execution of the maintenance support program is divided among the plurality of processors. Each of the processors is a device to execute the maintenance support program, as with the processor.

Data, information, signal values, and variable values that are utilized, processed, or outputted by the maintenance support program are stored in the memory, the storage, or a register or a cache memory in the processor.

The “unit” of the units of the devices of the maintenance support system may be read as “circuit”, “step”, “procedure”, “process”, or “circuitry”. The maintenance support program causes a computer to execute each of processes that are resultant from reading of the “unit” of the units of the devices of the maintenance support system as “process”. The “process” of the processes in the devices of the maintenance support system may be read as “program”, “program product”, “computer-readable storage medium having a program stored therein”, or “computer-readable recording medium having a program recorded therein”. Further, the maintenance support method is a method that is carried out by execution of the maintenance support program by the devices of the maintenance support system.

The maintenance support program stored in a computer-readable recording medium may be provided. Further, the maintenance support program may be provided as a program product.

### ***Other Configurations***

### <Modification>

In the present embodiment, functions of the units of the devices of the maintenance support system are implemented by software. In a modification, the functions of the units of the devices of the maintenance support system may be implemented by hardware.

Specifically, the devices of the maintenance support system include electronic circuits 11a, 21a in place of the processors 11, 21.

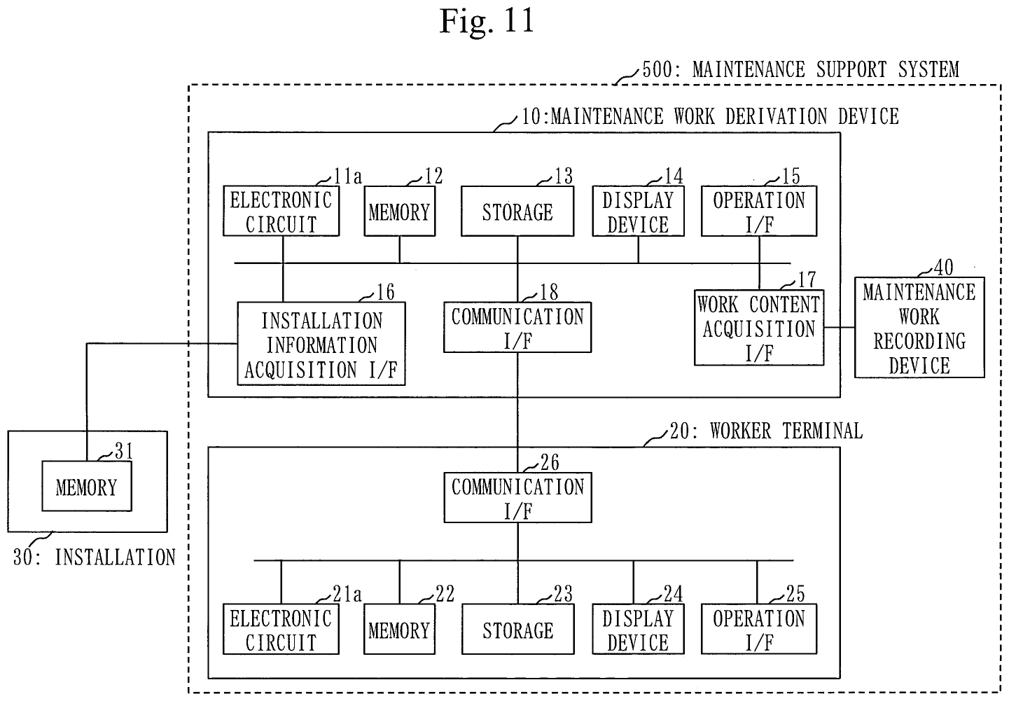

FIG. 11 is a diagram illustrating a hardware configuration example of the maintenance support system 500 according to the modification of the present embodiment.

The electronic circuits are dedicated electronic circuits to implement the functions of the units of the devices of the maintenance support system. Specifically, the electronic circuit is a single circuit, a composite circuit, a programmed processor, a parallelly programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the units of the devices of the maintenance support system may be implemented by one electronic circuit or may be implemented by being distributed among a plurality of electronic circuits.

In another modification, a portion of the functions of the units of the devices of the maintenance support system may be implemented by an electronic circuit and remaining functions may be implemented by software. Further, a portion or all of the functions of the units of the devices of the maintenance support system may be implemented by firmware.

Each of the processors and the electronic circuits may be referred to as processing circuitry. That is, the functions of the units of the devices of the maintenance support system are implemented by the processing circuitry.

### Embodiment 2

As for the present embodiment, differences from Embodiment 1 and additions to Embodiment 1 will be mainly described.

Configurations of the present embodiment that have functions similar to the functions of Embodiment 1 are provided with the same reference characters and description thereof is omitted.

In Embodiment 1, the maintenance work inference model in the units of the installation configuration elements is acquired from the element unit inference model 108. As for the present embodiment, an aspect in which a maintenance work inference model in the units of the elements that has undergone learning in an object installation is registered in the element unit inference model 108 will be described.

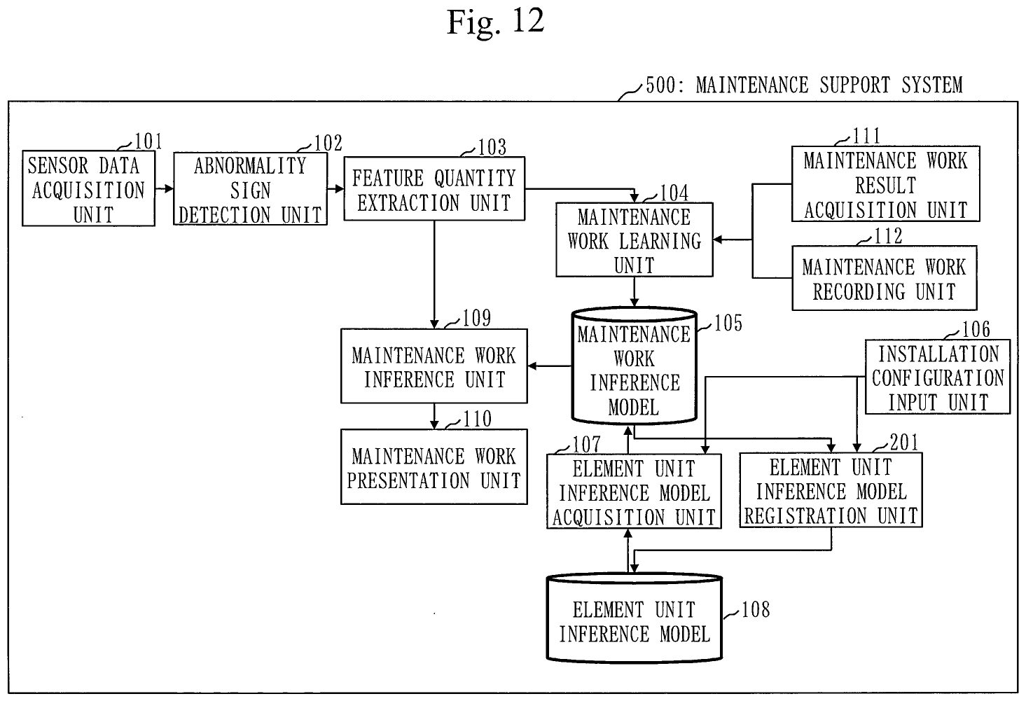

FIG. 12 is a diagram illustrating a functional configuration example of the maintenance support system 500 according to the present embodiment.

The present embodiment includes an element unit inference model registration unit 201 in addition to the functional configuration of Embodiment 1.

The element unit inference model registration unit 201 in FIG. 12 ties the maintenance work inference model 105, as a result of learning in the installation, to the installation configuration acquired by the installation configuration input unit 106 and registers the maintenance work inference model 105 in the element unit inference model 108.

The classification IDs for the installations, the sites, or the components are used for tying between the maintenance work inference model and the installation configuration. In case where a maintenance work inference model for an installation or a site or a component that has the same classification ID has been already registered in the element unit inference model 108, the model is mechanically overwritten. Alternatively, the user may be made to choose whether to overwrite or not.

Further, registration of the maintenance work inference model may be mechanically conducted after elapse of a given period. Alternatively, the user may conduct the registration at desired timing.

In the maintenance support system according to the present embodiment, as described above, the model having undergone learning in the installation is mechanically registered as the element unit inference model. According to the maintenance support system of the present embodiment, therefore, an effect is obtained in that the element unit inference model can be mechanically extended without trouble of manual construction.

In the maintenance support system according to the present embodiment, further, the “maintenance work inference model” having undergone learning in an installation is tied to elements of the installation, registered as the “inference model having undergone learning”, and thus can be reused for another installation of the same type.

### Embodiment 3

As for the present embodiment, differences from Embodiment 2 and additions to Embodiment 2 will be mainly described.

Configurations of the present embodiment that have functions similar to the functions of Embodiments 1 and 2 are provided with the same reference characters and description thereof is omitted.

In Embodiment 2, the maintenance work inference model in the units of the configuration elements that has undergone learning in one installation is registered in the element unit inference model 108. As for the present embodiment, an aspect in which a maintenance work inference model in the units of the configuration elements that has undergone learning in a plurality of installations is registered in the element unit inference model 108 will be described.

The maintenance support system 500 according to the present embodiment includes a learning inference execution unit 200 including the element unit inference model acquisition unit 107, the maintenance work inference unit 109, and the maintenance work learning unit 104, for each of the plurality of installations. Further, the maintenance support system 500 according to the present embodiment includes an element unit inference model saving unit 300 to enable the learning inference execution unit 200 of each of the plurality of installations to share and refer to the element unit inference model 108.

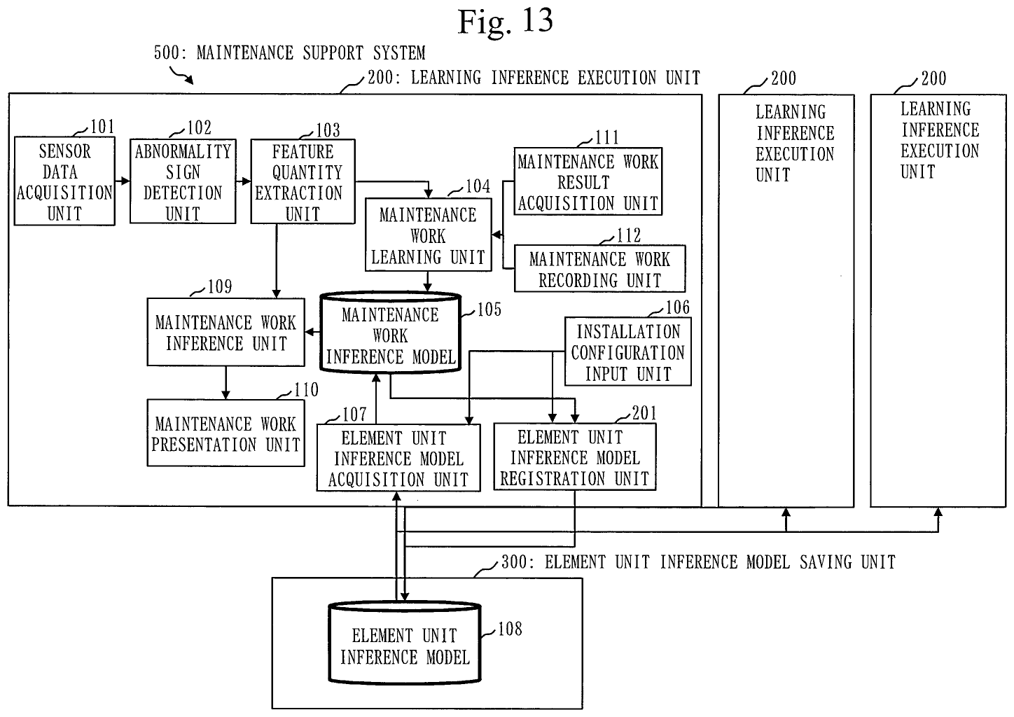

FIG. 13 is a diagram illustrating a functional configuration example of the maintenance support system 500 according to the present embodiment.

In FIG. 13, the learning inference execution unit 200 has other functions than the element unit inference model 108 has in the maintenance support system 500. The learning inference execution unit 200 is provided in each installation of the plurality of installations.

The element unit inference model saving unit 300 has functions of the element unit inference model 108 in the maintenance support system 500. In Embodiment 2, the one element unit inference model 108 is provided for the one maintenance support system 500. In the present embodiment, the plurality of learning inference execution units 200 share the one element unit inference model 108.

In the present embodiment, the learning inference execution unit 200 provided for an installation as an object registers a maintenance work inference model in the units of the configuration elements that has undergone learning in the installation, in the element unit inference model 108, so that results of the learning can be utilized by the learning inference execution units 200 provided for other installations as objects.

The learning inference execution units 200 and the element unit inference model saving unit 300 are enabled to act as hardware in separate devices. Further, connection among the devices by such a network as Internet or LAN makes it possible to share the learning results beyond physical distances. LAN is an abbreviation for Local Area Network.

In the maintenance support system according to the present embodiment, as described above, sharing of the learning results via a network, that is, sharing of the element unit inference model among the plurality of learning inference execution units is made available. According to the maintenance support system of the present embodiment, therefore, an effect is obtained in that the credibility of the priority or certainty factor of the maintenance work content to be presented to the maintenance worker can be increased by the learning based on achievements in the plurality of installations.

In the maintenance support system according to the present embodiment, on condition that a plurality of installations of the same type exist across factories or the like, the learning results for the installations can be mechanically summed up. If installations of the same type are operated in a factory A and a factory B, for instance, the “maintenance work inference model 105” is updated in the system of each of the factories while the updated model is reflected in the “element unit inference models 108”. Thus, the certainty factor of the model can be increased based on operational achievements in the installations of both the factories. More specifically, such flow as follows can be cited.

(1) The “maintenance work inference model 105” is constructed in each of the systems of the factory A and the factory B (step S101 of FIG. 10).

(2) In the factory A, the “maintenance work inference model 105” is updated with execution of detection of a sign of an abnormality and maintenance.

(3) In the system of the factory A, the “element unit inference models 108” are overwritten (updated) with the “maintenance work inference model 105”.

(4) The factory B is notified that the “element unit inference models 108” have been overwritten (updated) in the factory A.

(5) In the system of the factory B, the element unit inference model for the concerned element is acquired afresh from the “element unit inference model 108” and is set as the initial model of the “maintenance work inference model 105”.

In the maintenance support system according to the present embodiment, as described above, upon occurrence of update of the “maintenance work inference model 105” in a factory, the “element unit inference model 108” is overwritten (updated) as a result. It is made possible to sum up the learning results in the systems of a plurality of factories, by fresh use of the overwritten (updated) “element unit inference models 108” as the initial model in other factories.

Further, effects of the maintenance support system according to the present embodiment will be described with use of another specific example.

In another specific example, the learning inference execution unit according to the present embodiment is provided for each installation of installations A to J of the same sort or type.

When a failure occurs in the installation A, the maintenance work content “carry out component replacement in response to this current waveform of a motor” is carried out once and the certainty factor of the presented content in the maintenance work inference model is updated. Further, when a failure also occurs in each installation of the installations B to J, the certainty factor of the maintenance work inference model is similarly updated. Then, the maintenance work inference model is made capable of deriving a presented content that is as high in the certainty factor as a model having undergone a process ten times. In case where each of the installations A to J individually produces a model, on an assumption that the concerned failure occurs at a frequency of once in a period T1, time of T1×10 is required for obtainment of the equivalent certainty factor in each of the installations. In the present embodiment, however, production within time of T1 can be achieved.

### Embodiment 4

As for the present embodiment, differences from Embodiment 1 and additions to Embodiment 1 will be mainly described.

Configurations of the present embodiment that have functions similar to the functions of Embodiments 1 to 3 are provided with the same reference characters and description thereof is omitted.

In Embodiment 1, it is determined whether the sign of abnormality has been canceled or not, based on the result of the maintenance work and an evaluation is given to the maintenance work content carried out, based on a result of determination. As for the present embodiment, an aspect in which a maintenance worker gives an evaluation to the maintenance work content carried out will be described.

FIG. 14 is a diagram illustrating a functional configuration example of the maintenance support system 500 according to the present embodiment.

The present embodiment includes a maintenance work evaluation input unit 401 in addition to the functional configuration of Embodiment 1.

In FIG. 14, the maintenance work evaluation input unit 401 requests the maintenance worker to input an evaluation on effectiveness concerning whether the maintenance work content presented by the maintenance work presentation unit 110 has been effective or not for cancellation of an abnormality. The maintenance work evaluation input unit 401 receives the evaluation on the maintenance work content from the maintenance worker and delivers the evaluation to the maintenance work learning unit 104.

In the embodiment, as disclosed in step S108 and step S109 of FIG. 10, the maintenance work learning unit 104 makes an evaluation of the presented maintenance work content based on the success or failure in the cancellation of the sign of the abnormality. In the present embodiment, a result of the evaluation of the maintenance work content inputted by the maintenance worker is used. Specifically, an evaluation is heightened for a maintenance work content to which the maintenance worker has given a high evaluation and an evaluation is lowered for a maintenance work content to which the maintenance worker has given a low evaluation. Further, combination thereof with a manner of evaluation in Embodiment 1 may be made.

For instance, after an evaluation is made for the presented maintenance work content based on the success or failure in the cancellation of the sign of an abnormality as with Embodiment 1, the evaluation may be further heightened for the maintenance work content to which the maintenance worker has given a high evaluation or the evaluation may be lowered for the maintenance work content to which the maintenance worker has given a low evaluation.

In the maintenance support system according to the present embodiment, as described above, the maintenance worker gives an evaluation to the maintenance work content carried out. According to the maintenance support system of the present embodiment, therefore, an effect is obtained in that the maintenance work content can be evaluated based on manageability for a human as well so that the maintenance work content that is manageable for a human can be presented preferentially as a result of learning.

Further, on condition that a plurality of maintenance work contents have been presented to the maintenance worker, only the maintenance work content carried out immediately before the cancellation of the sign of the abnormality is not necessarily effective. In the maintenance support system according to the present embodiment, in such a case as well, the maintenance work content determined as being useful by the maintenance worker can be selected from among the plurality of maintenance work contents carried out. According to the maintenance support system of the present embodiment, therefore, the maintenance work content that contributes to the cancellation of the sign of the abnormality can be evaluated more highly.

As for above Embodiments 1 to 4, the units of the devices of the maintenance support system have been described as independent functional blocks. The configurations of the maintenance support devices, however, do not have to be such configurations as in the embodiments described above. The functional blocks of the maintenance support devices may have any configurations as long as the functions described in the embodiments described above can be implemented. Further, the maintenance support devices each may be a system configured by a plurality of devices instead of one device.

Further, a plurality of portions of Embodiments 1 to 4 may be embodied in combination. Alternatively, a portion of the embodiments may be embodied. Otherwise, the embodiments may be entirely or partially embodied in any combination.

That is, in Embodiments 1 to 4, free combinations of the embodiments, modifications of desired configuration elements in the embodiments, or omission of desired configuration elements in the embodiments is feasible.

Incidentally, the embodiments described above intrinsically adduce preferred examples and are not intended for limiting the scope of the present disclosure, the scope of applications of the present disclosure, and the scope of uses of the present disclosure. Diverse alterations to the embodiments described above may be made as appropriate. For instance, procedures described with use of the flowcharts or sequence diagrams may be altered appropriately.

### REFERENCE SIGNS LIST

10: maintenance work derivation device; 11, 21: processor; 11a, 21a: electronic circuit; 12, 22: memory; 13, 23: storage; 14, 24: display device; 15, 25: operation interface; 16: installation information acquisition interface; 17: work content acquisition interface; 18, 26: communication interface; 20: worker terminal; 30: installation; 31: memory; 40: maintenance work recording device; 101: sensor data acquisition unit; 102: abnormality sign detection unit; 103: feature quantity extraction unit; 104: maintenance work learning unit; 105: maintenance work inference model; 106: installation configuration input unit; 107: element unit inference model acquisition unit; 108: element unit inference model; 109: maintenance work inference unit; 110: maintenance work presentation unit; 111: maintenance work result acquisition unit; 112: maintenance work recording unit; 200: learning inference execution unit; 201: element unit inference model registration unit; 300: element unit inference model saving unit; 401: maintenance work evaluation input unit; 500: maintenance support system; 701: installation unit inference model; 702: site unit inference model; 703: component unit inference model; 901: recording object selection editing unit; 902: sensing information acquisition unit; 903: installation operation history acquisition unit; 904: worker input acquisition unit

The invention claimed is:

1. A maintenance support system to support maintenance work to be carried out by a maintenance worker for an installation, the maintenance support system comprising:
processing circuitry
to acquire installation configuration elements that are configuration elements of the installation, to acquire an element unit inference model for estimation of a maintenance work content in units of the installation configuration elements, and to set the acquired element unit inference model as initial values of a maintenance work inference model for estimation of the maintenance work content for the installation,
to estimate the maintenance work content to be presented to the maintenance worker by applying the maintenance work inference model to a feature quantity of an abnormality extracted from sensor data for the installation,
to iteratively evaluate whether the presented maintenance work content has been effective or not for cancellation of the abnormality, based on an evaluation of effectiveness of the presented maintenance work content, to learn an effective maintenance work content concerning the feature quantity of the abnormality, and to update the maintenance work inference model, and
to store the element unit inference model for each of classifications of said installations, classifications of sites configuring the installations, and classifications of components configuring the sites, wherein the installation configuration elements include the classifications of the installations, the classifications of the sites, and the classifications of components.

2. The maintenance support system according to claim 1, wherein
the processing circuitry acquires the element unit inference model for each of the classifications of the installations, the classifications of the sites, and the classifications of the components in the installations.

3. The maintenance support system according to claim 1, wherein
the processing circuitry presents the maintenance work content estimated to the maintenance worker.

4. The maintenance support system according to claim 2, wherein
the processing circuitry presents the maintenance work content estimated to the maintenance worker.

5. The maintenance support system according to claim 1, wherein
the processing circuitry ties the maintenance work inference model updated to the installation configuration elements and records the maintenance work inference model in the element unit inference model.

6. The maintenance support system according to claim 2, wherein
the processing circuitry ties the maintenance work inference model updated to the installation configuration elements and records the maintenance work inference model in the element unit inference model.

7. The maintenance support system according to claim 3, wherein
the processing circuitry ties the maintenance work inference model updated to the installation configuration elements and records the maintenance work inference model in the element unit inference model.

8. The maintenance support system according to claim 4, wherein
the processing circuitry ties the maintenance work inference model updated to the installation configuration elements and records the maintenance work inference model in the element unit inference model.

9. The maintenance support system according to claim 1, wherein
the processing circuitry requests the maintenance worker to input an evaluation on the effectiveness concerning whether the presented maintenance work content has been effective or not for cancellation of the abnormality.

10. The maintenance support system according to claim 2, wherein
the processing circuitry requests the maintenance worker to input an evaluation on the effectiveness concerning whether the presented maintenance work content has been effective or not for cancellation of the abnormality.

11. The maintenance support system according to claim 3, wherein
the processing circuitry requests the maintenance worker to input an evaluation on the effectiveness concerning whether the presented maintenance work content has been effective or not for cancellation of the abnormality.

12. The maintenance support system according to claim 4, wherein
the processing circuitry requests the maintenance worker to input an evaluation on the effectiveness concerning whether the presented maintenance work content has been effective or not for cancellation of the abnormality.

13. The maintenance support system according to claim 5, wherein
the processing circuitry requests the maintenance worker to input an evaluation on the effectiveness concerning whether the presented maintenance work content has been effective or not for cancellation of the abnormality.

14. The maintenance support system according to claim 6, wherein
the processing circuitry requests the maintenance worker to input an evaluation on the effectiveness concerning whether the presented maintenance work content has been effective or not for cancellation of the abnormality.

15. The maintenance support system according to claim 7, wherein
the processing circuitry requests the maintenance worker to input an evaluation on the effectiveness concerning whether the presented maintenance work content has been effective or not for cancellation of the abnormality.

16. The maintenance support system according to claim 8, wherein
the processing circuitry requests the maintenance worker to input an evaluation on the effectiveness concerning whether the presented maintenance work content has been effective or not for cancellation of the abnormality.

17. A maintenance support method to be used in a maintenance support system to support maintenance work to be carried out by a maintenance worker for an installation, the maintenance support method comprising:
acquiring installation configuration elements that are configuration elements of the installation, acquiring an element unit inference model for estimation of a maintenance work content in units of the installation configuration elements, and setting the acquired element unit inference model as initial values of a maintenance work inference model for estimation of the maintenance work content for the installation;
estimating the maintenance work content to be presented to the maintenance worker by applying the maintenance work inference model to a feature quantity of an abnormality extracted from sensor data for the installation;
iteratively evaluating whether the presented maintenance work content has been effective or not for cancellation of the abnormality, based on an evaluation of effectiveness of the presented maintenance work content, learning an effective maintenance work content concerning the feature quantity of the abnormality, and updating the maintenance work inference model; and
storing the element unit inference model for each of classifications of said installations, classifications of sites configuring the installations, and classifications of components configuring the sites, wherein the installation configuration elements include the classifications of the installations, the classifications of the sites, and the classifications of components.

18. A non-transitory computer readable medium storing a maintenance support program to be used in a maintenance support system to support maintenance work to be carried out by a maintenance worker for an installation, the maintenance support program that causes a computer to execute:
an element unit inference model acquisition process of acquiring installation configuration elements that are configuration elements of the installation, acquiring an element unit inference model for estimation of a maintenance work content in units of the installation configuration elements, and setting the acquired element unit inference model as initial values of a maintenance work inference model for estimation of the maintenance work content for the installation;
a maintenance work inference process of estimating the maintenance work content to be presented to the maintenance worker by applying the maintenance work inference model to a feature quantity of an abnormality extracted from sensor data for the installation;
a maintenance work learning process of iteratively evaluating whether the presented maintenance work content has been effective or not for cancellation of the abnormality, based on an evaluation of effectiveness of the presented maintenance work content, learning an effective maintenance work content concerning the feature quantity of the abnormality, and updating the maintenance work inference model; and
a storage process of storing the element unit inference model for each of classifications of said installations, classifications of sites configuring the installations, and classifications of components configuring the sites, wherein the installation configuration elements include the classifications of the installations, the classifications of the sites, and the classifications of components.
